(19) United States
(12) Patent Application Publication
(10) Pub. No.: US 2019/0063490 A1
(43) Pub. Date: Feb. 28, 2019

(54) BALL JOINT AND VEHICLE-DOOR OPENING/CLOSING APPARATUS

(71) Applicant: Mitsuba Corporation, Gunma (JP)

(72) Inventor: Takahiro Sakiyama, Kiryu-shi (JP)

(21) Appl. No.: 16/100,644

(22) Filed: Aug. 10, 2018

(30) Foreign Application Priority Data
Aug. 25, 2017 (JP) 2017-162369

(51) Int. Cl. F16C 11/06

(52) U.S. Cl. CPC F16C 11/06; E05F 15/622; E05Y 2900/546

(57) ABSTRACT

A ball joint includes a support groove. The support groove is formed to allow a support ring to be capable of being displaced to: a support ring expanded diameter position at which an inner diameter of the support ring becomes larger than a diameter of a spherical body in a state where the spherical body is fitted to the fit recess part; and a support ring shrunk diameter position which is positioned closer to an opening of the socket than the support ring expanded diameter position and at which the inner diameter of the support ring becomes smaller than the diameter of the spherical body in a state where the spherical body is fitted to the fit recess part, and a tool insertion hole in which a tool is capable of being inserted and which allow a position that corresponds to the support ring shrunk diameter position of the support groove to communicate with an external surface of a circumferential wall of the socket is formed to penetrate on the circumferential wall of the socket.

### CROSS-REFERENCE TO RELATED APPLICATION

Priority is claimed on Japanese Patent Application No. 2017-162369, filed on Aug. 25, 2017, the contents of which are incorporated herein by reference.

### BACKGROUND

### Field of the Invention

The present invention relates to a ball joint and a vehicle-door opening/closing apparatus.

### Background

In the related art, as a vehicle-door opening/closing apparatus, a configuration is known which includes an actuator that is provided between the vicinity of an opening part on a vehicle body side and a rear door which is provided at the opening part so as to be capable of being opened and closed and that operates the rear door to be opened and closed (for example, refer to Japanese Unexamined Patent Application, First Publication No. 2014-100956). The actuator includes a first housing having a cylinder shape, a second housing that is formed to have a larger diameter than that of the first housing and that is inserted from one end side of the first housing, a motor part (motor) that is provided inside the first housing, a screw spindle that is connected to the motor part via a speed reducer and that is arranged concentrically with the motor part, a spindle nut that is fixed to the second housing and that is threaded to the screw spindle, and a compression coil spring that is accommodated inside the second housing and that biases the first housing and the second housing in an elongation direction.

A first end in an axial direction of the actuator is connected to a vehicle body via a ball joint, and a second end in the axial direction of the actuator is connected to a rear door via a ball joint. That is, a socket is provided on each of the other end of the first housing and one end of the second housing. The socket of the first housing is connected rotatably to a ball stud that is provided on a body of the vehicle. On the other hand, the socket of the second housing is connected rotatably to a ball stud that is provided on the rear door.

More specifically, the socket has a fit recess part to which a spherical body (spherical head part) of the ball stud is fitted. A support groove (fit groove) having an annular shape is provided to be recessed on an inner circumference of an opening portion of the fit recess part, and a C ring having a break part at a portion of the annular shape of the C ring is fitted inside this fit groove. By reducing the size of the opening portion of the fit recess part using the C ring that is capable of being expanded and shrunk by elastic deformation thereof, the spherical body of the ball stud is held inside the fit recess part.

According to such a configuration, in the actuator, when the motor part is driven to be rotated, the rotation of an output shaft of the motor part is transmitted via a speed reducer to the screw spindle, and the screw spindle is rotated.

By the rotation of the screw spindle, the spindle nut that is threaded to the screw spindle is moved in an axial direction of the screw spindle. Thereby, the second housing appears and disappears with respect to the first housing, and the actuator is extended and shrunk to perform an opening/closing operation of the rear door. In this case, since each socket is connected rotatably to the ball stud, excessive stress is not applied between the actuator and the body and between the actuator and the rear door, and the opening/closing operation of the rear door is smoothly performed.

Once the ball stud is connected to the socket, due to the structure, it is difficult to disassemble the socket and the ball stud. Therefore, for example, a configuration is known in which, when performing maintenance of the vehicle-door opening/closing apparatus, it is possible to remove the socket itself from the actuator while keeping a state where the ball stud is connected to the socket. That is, a protruding fit part is provided on the actuator. On the other hand, a fit hole in which the protruding fit part is capable of being inserted is provided on the socket. Further, a fixation pin as a fixation member that fixes the protruding fit part is provided inside the fit hole.

### SUMMARY

However, in the related art described above, in order to obtain a configuration in which it is possible to remove the socket itself from the actuator while keeping a state where the ball stud is connected to the socket, the configuration of the vehicle-door opening/closing apparatus becomes complicated. Therefore, there is a problem in that the manufacturing cost of the vehicle-door opening/closing apparatus is increased.

An aspect of the present invention provides a ball joint and a vehicle-door opening/closing apparatus having a simplified structure and capable of reducing a manufacturing cost and being disassembled.

A ball joint according to an aspect of the present invention includes: a support shaft having a spherical body at an end part; a socket on which a support groove is provided to be recessed on an inner circumferential surface of the fit recess part throughout an entire circumference and which has a fit recess part to which the spherical body is rotatably fitted; and a support ring that is stored in the support groove, that regulates dropping off of the spherical body which is fitted to the fit recess part, and that is elastically deformable, wherein the support groove is formed to allow the support ring to be capable of being displaced to: a support ring expanded diameter position at which an inner diameter of the support ring becomes larger than a diameter of the spherical body in a state where the spherical body is fitted to the fit recess part; and a support ring shrunk diameter position which is positioned closer to an opening of the socket than the support ring expanded diameter position and at which the inner diameter of the support ring becomes smaller than the diameter of the spherical body in a state where the spherical body is fitted to the fit recess part, and at least two tool insertion holes in which a tool is capable of being inserted and which allow a position that corresponds to the support ring shrunk diameter position of the support groove to communicate with an external surface of a circumferential wall of the socket are formed to penetrate on the circumferential wall of the socket.

According to such a configuration, when the tool is inserted in the tool insertion hole, it is possible to push up the support ring that is present at the support ring shrunk diameter position and move the support ring to the support ring expanded diameter position by the tool. When the support ring is moved to the support ring expanded diameter position, the support ring is pushed and expanded so as to be deformed such that the diameter is expanded, and it is possible to remove the spherical body from the socket. In this way, by a simple configuration, it becomes possible to remove the spherical body from the socket. Further, for example, it is not necessary to employ a structure in which it is possible to remove the socket itself from the actuator as in the related art. Therefore, it is possible to simplify the structure of the ball joint and to reduce the manufacturing cost while allowing the ball joint to have a configuration capable of being disassembled.

In the ball joint described above, when a diameter of a cross-section of the support ring is represented by D, and a groove width in a depth direction of the fit recess part in the support groove is represented by W, the groove width W may be set such that a relationship W≥2D is satisfied.

According to such a configuration, it is possible to reliably move the support ring from the support ring shrunk diameter position to the support ring expanded diameter position inside the support groove.

In the ball joint described above, the tool insertion holes may be arranged on the circumferential wall of the socket so as to be spaced at an interval of 180°.

According to such a configuration, a tool is inserted from each of the two tool insertion holes, and by using these tools, it is possible to sandwich the center in the radial direction of the support ring and to lift up the support ring from both sides. Therefore, the support ring is not tilted in the support groove, and it is possible to easily and reliably move the support ring from the support ring shrunk diameter position to the support ring expanded diameter position. Accordingly, it is possible to facilitate the work of disassembling the spherical body from the socket.

In the ball joint described above, the tool insertion hole may be formed to be tilted with respect to the depth direction of the fit recess part such that an opening position on the external surface side of the circumferential wall of the socket in the tool insertion hole is at a position closer to an opening of the fit recess part than an opening position on the support groove side in the tool insertion hole.

According to such a configuration, only by inserting the tool in the tool insertion hole, the support ring that is present at the support ring shrunk diameter position is capable of being pushed up to the support ring expanded diameter position using a front end of the tool. Therefore, it is possible to further facilitate the work of disassembling the spherical body from the socket.

A vehicle-door opening/closing apparatus according to another aspect of the present invention includes: a ball joint described above; and an actuator that is provided between a vehicle body and a door capable of opening and closing an opening part of the vehicle body and that is used for performing an opening/closing operation of the door, wherein at least any one of the actuator and the vehicle body, and the actuator and the door are connected via the ball joint.

According to such a configuration, it is possible to provide a vehicle-door opening/closing apparatus having a simplified structure and capable of reducing a manufacturing cost and being disassembled.

According to an aspect of the present invention, when the tool is inserted in the tool insertion hole, it is possible to push up the support ring that is present at the support ring shrunk diameter position and move the support ring to the support ring expanded diameter position by the tool. When the support ring is moved to the support ring expanded diameter position, the support ring is pushed and expanded so as to be deformed such that the diameter is expanded, and it is possible to remove the spherical body from the socket. In this way, by a simple configuration, it becomes possible to remove the spherical body from the socket. Further, for example, it is not necessary to employ a structure in which it is possible to remove the socket itself from the actuator as in the related art. Therefore, it is possible to simplify the structure of the ball joint and to reduce the manufacturing cost while allowing the ball joint to have a configuration capable of being disassembled.

### BRIEF DESCRIPTION OF THE DRAWINGS

FIG. 1 is a longitudinal cross-sectional view of a vehicle body of an automobile in an embodiment of the present invention.

FIG. 2 is a perspective view of a ball joint in the first embodiment of the present invention.

FIG. 3 is a side view of the ball joint in which a socket in the first embodiment of the present invention is shown in a cross-section along an A-A line of FIG. 2.

FIG. 4 is a view showing a disassembly method of the ball joint in the first embodiment of the present invention.

FIG. 5 is a configuration view of a ball joint in a second embodiment of the present invention.

### DESCRIPTION OF THE EMBODIMENTS

Next, an embodiment of the present invention will be described with reference to the drawings.

### (Vehicle-Door Opening/Closing Apparatus)

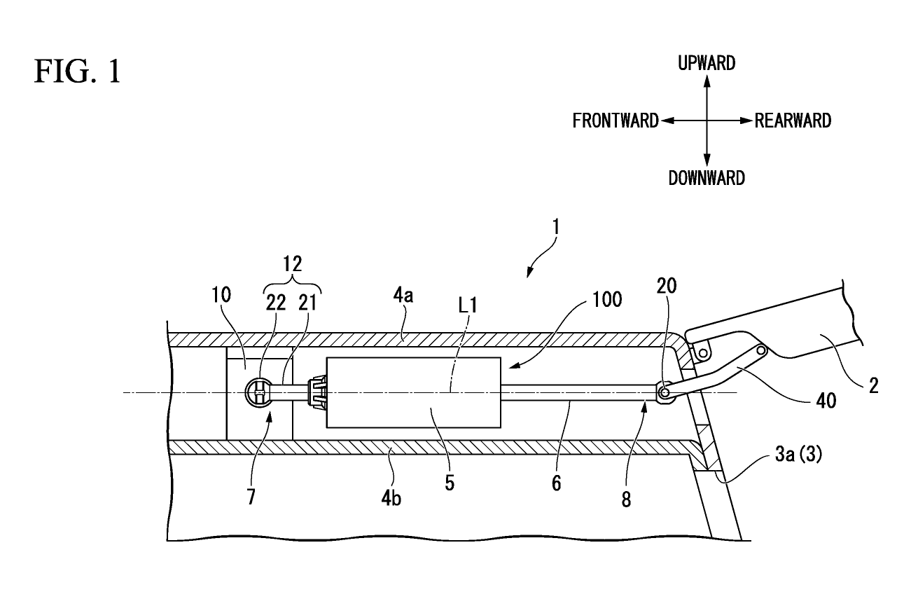

FIG. 1 is a longitudinal cross-sectional view of a vehicle body 1 of an automobile that includes a vehicle-door opening/closing apparatus 100 in an embodiment of the present invention. In the following description, a front-to-rear direction in a travel direction of the vehicle body 1 is simply referred to as a front-to-rear direction, a frontward direction in the travel direction is simply referred to as a frontward direction, a rearward direction in the travel direction is simply referred to as a rearward direction, an upward direction in a gravity direction is simply referred to as an upward direction, a downward direction in the gravity direction is simply referred to as a downward direction, and a vehicle width direction of the vehicle body 1 is referred to as a right-to-left direction. In FIG. 1, the leftward direction refers to the frontward direction, and the rightward direction refers to the rearward direction.

As shown in FIG. 1, the vehicle-door opening/closing apparatus 100 is an apparatus for opening and closing a rear door 2. The vehicle-door opening/closing apparatus 100 is provided between a roof outer panel 4a and a roof inner panel 4b that constitute a roof of the vehicle body 1. The rear door 2 is provided on an upper portion 3a of an opening part 3 so as to be capable of being opened and closed with respect to the opening part 3 that is formed on a rear part of the vehicle body 1.

The vehicle-door opening/closing apparatus 100 includes an actuator main body 5, an operation shaft 6 that is provided on a rear part of the actuator main body 5 and that is provided to be capable of being extended and shrunk along the front-to-rear direction, a ball joint 7 that is provided on a front part of the actuator main body 5 and that fixes the actuator main body 5 to the vehicle body 1, and a ball joint 8 that is provided on a front end of the operation shaft 6 and that fixes the operation shaft 6 to the rear door 2 via a hinge mechanism 40.

The actuator main body 5 is formed of a motor (not shown), a screw spindle that is rotated in response to a drive force of the motor, a spindle nut that is threaded to the screw spindle, and the like.

The actuator main body 5 is formed such that the spindle nut is moved along an axial direction of the screw spindle in accordance with the rotation of the screw spindle. The operation shaft 6 is connected to the spindle nut. Thereby, the operation shaft 6 is extended or shrunk toward the rearward direction from the actuator main body 5.

### First Embodiment

### (Ball Joint)

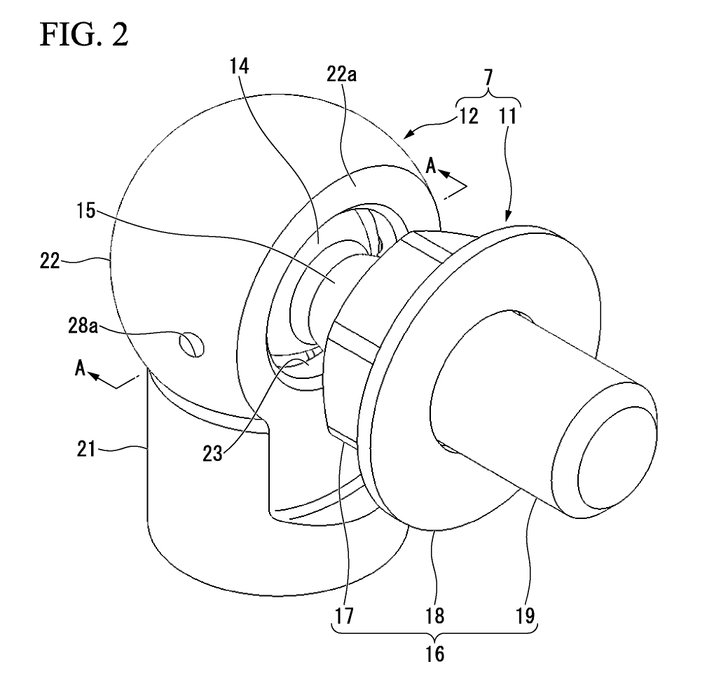

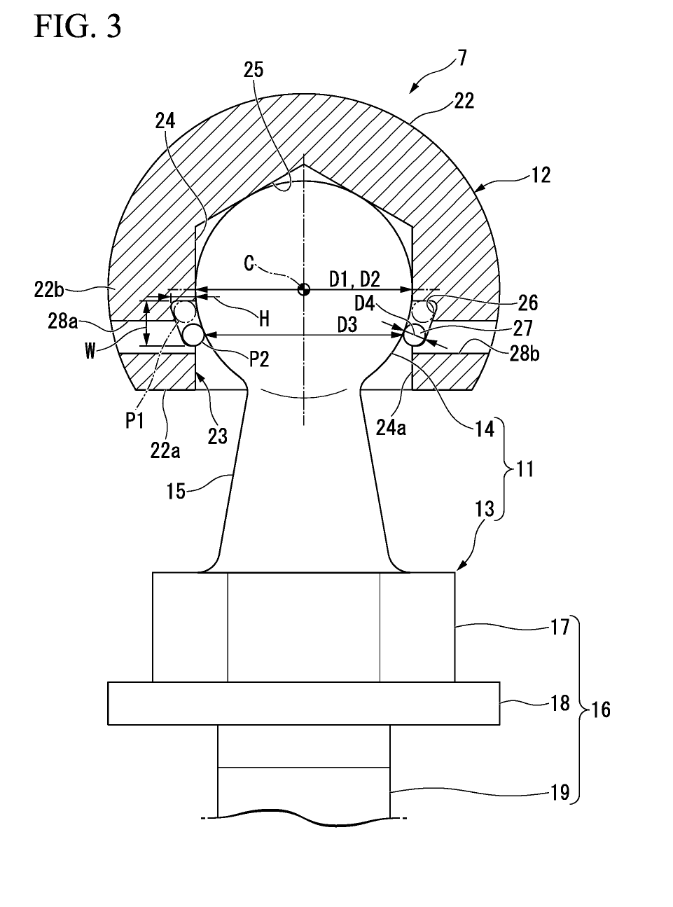

FIG. 2 is a perspective view of the ball joint 7 on the actuator main body 5 side in the first embodiment. FIG. 3 is a side view of the ball joint 7 in which a socket 12 of the ball joint 7 is shown in a cross-section along an A-A line of FIG. 2.

The ball joint 8 on the operation shaft 6 side also has a basic configuration that is similar to a basic configuration of the ball joint 7 on the actuator main body 5 side. Therefore, in the following, descriptions of the basic configuration of the ball joint 8 are omitted, and the ball joint 8 is described, if necessary.

As shown in FIG. 1 to FIG. 3, the ball joint 7 includes a ball stud 11 that is attached to a bracket 10 which is provided on the roof outer panel 4a and the socket 12 that is attached to the actuator main body 5.

The ball stud 11 is formed of a metal having high rigidity. The ball stud 11 is formed of a support shaft 13 and a spherical head part 14 (spherical body) that is integrally molded on one end of the support shaft 13. The support shaft 13 is formed of a shaft main body 15 having one end on which the spherical head part 14 is integrally molded and a bolt part 16 that is integrally molded on the other end of the shaft main body 15.

The bolt part 16 is formed of a head portion 17 that is connected to the shaft main body 15, a flat seat portion 18 that is integrally molded on a surface of the head part 17 on an opposite side of the shaft main body 15, and a male screw portion 19 that protrudes from a side of the flat seat portion 18 on an opposite side of the head portion 17. The head portion 17 is formed in a polygonal shape and is capable of engaging with a tool such as a hexagonal spanner, for example. The male screw portion 19 is threaded to the bracket 10, and by the flat seat portion 18 coming into contact with the bracket 10, the ball stud 11 is positioned with respect to and is fixed to the bracket 10

A female screw part (not shown) is engraved on a front end of the operation shaft 6. The male screw portion 19 of the ball stud 11 is threaded into the female screw part, and thereby, the ball stud 11 is attached to the front end of the operation shaft 6. However, the embodiment is not limited thereto. The bolt part 16 of the ball stud 11 may be excluded, and it is also possible to integrally mold the support shaft 13 and the operation shaft 6 of the ball stud 11 or joint the support shaft 13 and the operation shaft 6 by welding.

The socket 12 is formed of a neck part 21 that has a cylindrical shape and that is provided to protrude frontward from a front part of the actuator main body 5 and a socket main body 22 that is integrally molded on an end of the neck part 21 on an opposite side of the actuator main body 5. The socket main body 22 is formed in a substantially spherical shape and has a flat surface 22a that is formed to be flat such that a part of the socket main body 22 is removed. Further, the socket 12 is formed such that a plane direction of the flat surface 22a and an axial direction of the neck part 21 are substantially parallel with each other. Further, the socket 12 is arranged such that the flat surface 22a is directed to the bracket 10.

A fit recess part 23 to which the spherical head part 14 of the ball stud 11 is capable of being rotatably fitted is formed on the flat surface 22a of the socket main body 22. The fit recess part 23 has a cylindrical inner circumferential surface 24 and a bottom surface 25 that is formed on an opposite side of an opening part 24a of the cylindrical inner circumferential surface 24. An inner diameter D1 of the cylindrical inner circumferential surface 24 is set to be substantially the same as or slightly larger than a diameter D2 of the spherical head part 14.

The bottom surface 25 is formed in a substantially conical shape such that a front is sharpened toward the opposite side of the opening part 24a. The spherical head part 14 is in slidable contact with the cylindrical inner circumferential surface 24 and the bottom surface 25 of the fit recess part 23 in a state where the spherical head part 14 is rotatably fitted to the fit recess part 23. In the following description, a wall part that forms the cylindrical inner circumferential surface 24 of the socket main body 22 is referred to as a circumferential wall 22b.

A support groove 26 having an annular shape is provided to be recessed on the cylindrical inner circumferential surface 24 of the fit recess part 23 throughout an entire circumference. A C-shaped ring 27 (support ring) that is elastically deformable is stored in the support groove 26. The C-shaped ring 27 regulates dropping off of the spherical head part 14 that is fitted to the fit recess part 23 from the fit recess part 23. The C-shaped ring 27 is formed such that an inner diameter D3 is smaller than the diameter D2 of the spherical head part 14 in an unloaded state.

The support groove 26 is formed from a position slightly closer to the opening part 24a of the fit recess part 23 than a center C of the spherical head part 14 to a position before the opening part 24a in a state where the spherical head part 14 is fitted to the fit recess part 23. More specifically, when a groove width in a depth direction of the fit recess part 23 in the support groove 26 is represented by W, a groove depth in a radial direction of the fit recess part 23 in the support groove 26 is represented by H, and a diameter of a cross-section of the C-shaped ring 27 is represented by D4, the groove width W, the groove depth H, and the diameter D4 are set such that the following Expressions (1), (2) are satisfied.

H≈D4 (1)

W≥2×D4 (2)

By satisfying above Expression (2), the support groove 26 is formed to be deformable such that the inner diameter D3 of the C-shaped ring 27 is enlarged to be substantially the same as or slightly larger than the diameter D2 of the spherical head part 14 when the C-shaped ring 27 is positioned closest to the center C of the spherical head part 14 inside the support groove 26 (refer to the C-shaped ring 27 represented by a two-dot chain line in FIG. 3. Hereinafter, this position is referred to as a support ring expanded diameter position P1).

The support groove 26 is formed such that the inner diameter D3 of the C-shaped ring 27 is smaller than the diameter D2 of the spherical head part 14 when the C-shaped ring 27 is positioned closest to the opening part 24a of the fit recess part 23 inside the support groove 26 (refer to the C-shaped ring 27 represented by a solid line in FIG. 3. Hereinafter, this position is referred to as a support ring shrunk diameter position P2). In this way, the support groove 26 is formed such that the C-shaped ring 27 is capable of being displaced from the support ring shrunk diameter position P2 to the support ring expanded diameter position P1.

Further, two tool insertion holes 28a, 28b which allow an external surface of the circumferential wall 22b and the support groove 26 to communicate with each other are formed on the circumferential wall 22b of the socket main body 22. The tool insertion holes 28a, 28b are formed such that a direction orthogonal to the axial direction of the support shaft 13 becomes an axial direction. The tool insertion holes 28a, 28b are arranged so as to face each other such that the support shaft 13 is a center. In other words, the two tool insertion holes 28a, 28b are arranged so as to be spaced at an interval of 180° in the circumferential direction, and axial directions of the two tool insertion holes 28a, 28b are arranged so as to be positioned on a same straight line. Further, the tool insertion holes 28a, 28b communicate with a point that corresponds to the support ring shrunk diameter position P2 of the support groove 26.

### (Assembly Method and Disassembly Method of Ball Joint)

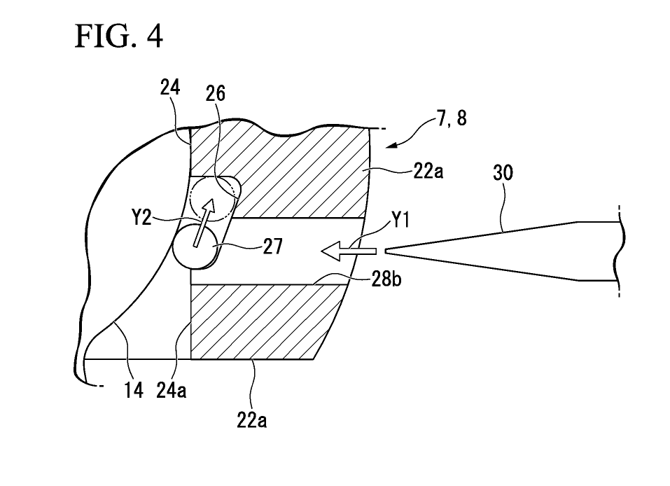

Next, an assembly method and a disassembly method of ball joints 7, 8 are described with reference to FIG. 4.

FIG. 4 is a view showing a disassembly method of the ball joints 7, 8.

First, the assembly method of the ball joints 7, 8 is described.

When assembling the ball joints 7, 8, the C-shaped ring 27 is stored in advance in the support groove 26 of the socket 12. The C-shaped ring 27 is formed such that the inner diameter D3 (refer to FIG. 3) is smaller than the diameter D2 of the spherical head part 14 in an unloaded state. Therefore, at a time point when the C-shaped ring 27 is stored in the support groove 26 of the socket 12, the C-shaped ring 27 is arranged at the support ring shrunk diameter position P2 by a restoring force of a spring.

In this state, when the spherical head part 14 of the ball stud 11 is inserted in the fit recess part 23 via the opening part 24a of the socket 12, the C-shaped ring 27 is pushed up by the spherical head part 14 while being elastically deformed and is moved to the support ring expanded diameter position P1 of the support groove 26. Thereby, the inner diameter D3 of the C-shaped ring 27 is enlarged, and the spherical head part 14 is fitted to the fit recess part 23 via the C-shaped ring 27. Then, the restoring force acts on the C-shaped ring 27, and the C-shaped ring 27 is moved again to the support ring shrunk diameter position P2 while being deformed such that the inner diameter D3 is shrunk. Therefore, the dropping off of the spherical head part 14 from the fit recess part 23 is regulated by the C-shaped ring 27. Thereby, the assembly work of the ball joints 7, 8 is completed.

Next, the disassembly method of the ball joints 7, 8 is described.

As shown in FIG. 4, when disassembling the ball joints 7, 8, a front end of a tool 30 is inserted in each of the tool insertion holes 28a, 28b from an outer side of the socket 12 (refer to an arrow Y1 in FIG. 4). The tool insertion hole 28a is not shown in FIG. 4. Examples of the tool 30 can preferably include a tool having a sharpened front end such as a flat-blade screwdriver.

When the front end of the tool 30 is inserted in each of the tool insertion holes 28a, 28b, the C-shaped ring 27 is pushed up by the front ends, and the C-shaped ring 27 is moved to the support ring expanded diameter position P1 while being deformed such that the inner diameter D3 is enlarged (refer to an arrow Y2 in FIG. 4). At this time, since the two tool insertion holes 28a, 28b are arranged so as to face each other such that the support shaft 13 (refer to FIG. 3) is a center, the C-shaped ring 27 is pushed up by the tool 30 from both sides that are spaced by 180° in the circumferential direction. Therefore, it is possible to prevent the C-shaped ring 27 from being tilted with respect to the axial direction of the support shaft 13 inside the support groove 26, and it is possible to easily push up the C-shaped ring 27.

When the C-shaped ring 27 is moved to the support ring expanded diameter position P1, the inner diameter D3 of the C-shaped ring 27 is enlarged again to be substantially the same as or slightly larger than the diameter D2 of the spherical head part 14. Therefore, it is possible to remove the spherical head part 14 from the fit recess part 23. By removing the spherical head part 14 from the fit recess part 23, the disassembly work of the ball joints 7, 8 is completed.

In this way, in the first embodiment described above, the groove width W and the groove depth H of the support groove 26 that is provided to be recessed on the fit recess part 23 are set such that Expressions (1), (2) described above are satisfied. That is, the support groove 26 is formed such that the C-shaped ring 27 is capable of being displaced from the support ring shrunk diameter position P2 to the support ring expanded diameter position P1. Further, the tool insertion holes 28a, 28b, which allow the external surface of the circumferential wall 22b and the point that corresponds to the support ring shrunk diameter position P2 of the support groove 26 to communicate with each other, are formed on the circumferential wall 22b of the socket 12. Therefore, only by inserting the tool 30 in the tool insertion holes 28a, 28b, the C-shaped ring 27 is capable of being easily moved from the support ring shrunk diameter position P2 to the support ring expanded diameter position P1. As a result, the C-shaped ring 27 is deformed such that the inner diameter D3 is enlarged, and it is possible to easily remove the ball stud 11 from the socket 12.

In this way, by a simple structure, it becomes possible to remove the ball stud 11 from the socket 12, and, for example, it is not necessary to employ a structure in which it is possible to remove the socket 12 itself from the actuator main body 5 as in the related art. Accordingly, it is possible to simplify the structure of the ball joint 7 and to reduce the manufacturing cost while allowing the ball joint 7 to have a configuration capable of being disassembled.

Further, the two tool insertion holes 28a, 28b that are formed on the socket 12 are arranged so as to face each other such that the support shaft 13 (refer to FIG. 3) is a center, and therefore, it is possible to push up the C-shaped ring 27 to the support ring expanded diameter position P1 by the tool 30 from both sides that are spaced at an interval of 180° in the circumferential direction when removing the ball stud 11 from the socket 12. Therefore, it is possible to prevent the C-shaped ring 27 from being tilted with respect to the axial direction of the support shaft 13 inside the support groove 26, and it is possible to easily push up the C-shaped ring 27. Accordingly, it is possible to easily perform the disassembly work of the ball joints 7, 8.

### Second Embodiment

### (Ball Joint)

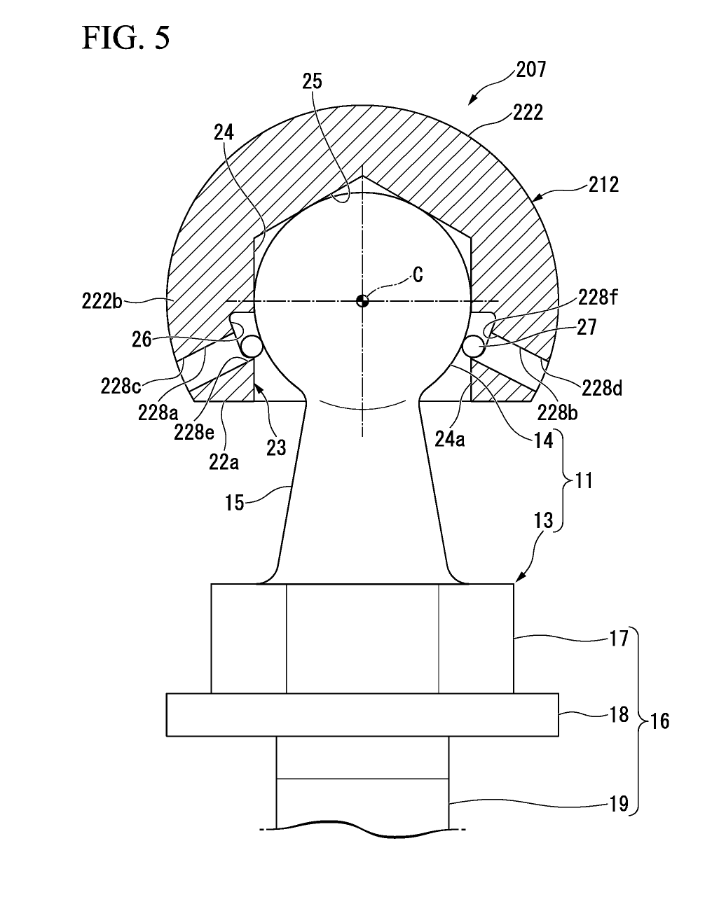

Next, a second embodiment is described with reference to FIG. 5.

FIG. 5 is a configuration view of a ball joint 207 in the second embodiment and corresponds to FIG. 3 of the first embodiment described above. The same configurations as the first embodiment described above are given by the same reference numerals, and descriptions of the configurations are omitted.

As shown in FIG. 5, basic configurations of the ball joint 207 of the second embodiment, such as a configuration in which the ball stud 11 and a socket 212 are provided, a configuration in which the fit recess part 23 to which the spherical head part 14 of the ball stud 11 is fitted is formed on the socket 212, a configuration in which the support groove 26 having an annular shape is provided to be recessed on the cylindrical inner circumferential surface 24 of the fit recess part 23 throughout the entire circumference, and a configuration in which the C-shaped ring 27 that is elastically deformable is stored in the support groove 26 are similar to those of the first embodiment described above.

Two tool insertion holes 228a, 228b are formed on a circumferential wall 222b of a socket main body 222 of the socket 212 of the second embodiment. The two tool insertion holes 228a, 228b are arranged so as to face each other such that the support shaft 13 is a center. In other words, the two tool insertion holes 228a, 228b are arranged so as to be spaced at an interval of 180° in the circumferential direction.

The shapes of the two tool insertion holes 228a, 228b are different from the shapes of the tool insertion holes 28a, 28b in the first embodiment described above.

That is, in the tool insertion holes 228a, 228b of the second embodiment, openings 228c, 228d on an external surface side in the circumferential wall 222b of the socket main body 222 are positioned closer to the opening part 24a side of the socket 212 than openings 228e, 228f on the support groove 26 side. Thereby, the tool insertion holes 228a, 228b are formed such that axial directions of the tool insertion holes 228a, 228b are tilted with respect to the depth direction (axial direction of the support shaft 13) of the fit recess part 23.

In such a configuration, when disassembling the ball joint 207 and when the tool 30 (refer to FIG. 4, not shown in FIG. 5) is inserted in each of the tool insertion holes 228a, 228b from the outside of the socket 212, the C-shaped ring 27 is pushed up toward the support ring expanded diameter position P1 by the front end of the tool 30. Therefore, in addition to the advantages similar to the first embodiment described above, it is possible to further easily disassemble the ball joint 207.

The present invention is not limited to the embodiments described above, and various changes can be added to the embodiments described above without departing from the scope of the invention.

For example, the above embodiments are described using an example in which the vehicle-door opening/closing apparatus 100 is a vehicle-door opening/closing apparatus for opening and closing the rear door 2 of the vehicle body 1. Further, the above embodiments are described using an example in which the vehicle-door opening/closing apparatus 100 is provided between the roof outer panel 4a and the roof inner panel 4b. However, the embodiments are not limited thereto, and it is possible to use the vehicle-door opening/closing apparatus 100 for a variety of apparatuses. Further, even when using the vehicle-door opening/closing apparatus 100 as a vehicle-door opening/closing actuator, it is possible to provide the vehicle-door opening/closing apparatus 100 at a variety of points of the vehicle body 1.

Further, the above embodiments are described using an example in which the actuator main body 5 is fixed to the vehicle body 1 via the ball joint 7. Further, the above embodiments are described using an example in which the operation shaft 6 is fixed to the rear door 2 via the ball joint 8. However, the embodiments are not limited thereto, and at least any of the actuator main body 5 and the operation shaft 6 may be fixed to the vehicle body 1 or the rear door 2 via any of the ball joints 7, 8.

Further, the above embodiments are described using an example in which the two tool insertion holes 28a, 28b are formed on the socket 12 of the ball joint 7, and the two tool insertion holes 228a, 228b are formed on the socket 212 of the ball joint 207. However, the embodiments are not limited thereto, and two or more tool insertion holes 28a, 28b may be formed on the socket 12, and two or more tool insertion holes 228a, 228b may be formed on the socket 212.

Further, the above embodiments are described using an example in which the C-shaped ring 27 is stored in the support groove 26 of the sockets 12, 212. However, the embodiments are not limited thereto, and the ring that is stored in the support groove 26 may be a ring that is deformable such that the inner diameter of the ring is capable of being enlarged by elastic deformation.

1. A ball joint, comprising:
a support shaft having a spherical body at an end part;
a socket on which a support groove is provided to be recessed on an inner circumferential surface of the fit recess part throughout an entire circumference and which has a fit recess part to which the spherical body is rotatably fitted; and
a support ring that is stored in the support groove, that regulates dropping off of the spherical body which is fitted to the fit recess part, and that is elastically deformable,
wherein the support groove is formed to allow the support ring to be capable of being displaced to: a support ring expanded diameter position at which an inner diameter of the support ring becomes larger than a diameter of the spherical body in a state where the spherical body is fitted to the fit recess part; and a support ring shrunk diameter position which is positioned closer to an opening of the socket than the support ring expanded diameter position and at which the inner diameter of the support ring becomes smaller than the diameter of the spherical body in a state where the spherical body is fitted to the fit recess part, and
at least two tool insertion holes in which a tool is capable of being inserted and which allow a position that corresponds to the support ring shrunk diameter position of the support groove to communicate with an external surface of a circumferential wall of the socket are formed to penetrate on the circumferential wall of the socket.

2. The ball joint according to claim 1,
wherein, when a diameter of a cross-section of the support ring is represented by D, and a groove width in a depth direction of the fit recess part in the support groove is represented by W, the groove width W is set such that a relationship W≥2D is satisfied.

3. The ball joint according to claim 1,
wherein the tool insertion holes are arranged on the circumferential wall of the socket so as to be spaced at an interval of 180°.

4. The ball joint according to claim 2,
wherein the tool insertion holes are arranged on the circumferential wall of the socket so as to be spaced at an interval of 180°.

5. The ball joint according to claim 1,
wherein the tool insertion hole is formed to be tilted with respect to the depth direction of the fit recess part such that an opening position on the external surface side of the circumferential wall of the socket in the tool insertion hole is at a position closer to an opening of the fit recess part than an opening position on the support groove side in the tool insertion hole.

6. The ball joint according to claim 2,
wherein the tool insertion hole is formed to be tilted with respect to the depth direction of the fit recess part such that an opening position on the external surface side of the circumferential wall of the socket in the tool insertion hole is at a position closer to an opening of the fit recess part than an opening position on the support groove side in the tool insertion hole.

7. The ball joint according to claim 3,
wherein the tool insertion hole is formed to be tilted with respect to the depth direction of the fit recess part such that an opening position on the external surface side of the circumferential wall of the socket in the tool insertion hole is at a position closer to an opening of the fit recess part than an opening position on the support groove side in the tool insertion hole.

8. The ball joint according to claim 4,
wherein the tool insertion hole is formed to be tilted with respect to the depth direction of the fit recess part such that an opening position on the external surface side of the circumferential wall of the socket in the tool insertion hole is at a position closer to an opening of the fit recess part than an opening position on the support groove side in the tool insertion hole.

9. A vehicle-door opening/closing apparatus, comprising:
the ball joint according to claim 1; and
an actuator that is provided between a vehicle body and a door capable of opening and closing an opening part of the vehicle body and that is used for performing an opening/closing operation of the door,
wherein at least any one of the actuator and the vehicle body, and the actuator and the door are connected via the ball joint.
